(19) United States
(12) Patent Application Publication
(10) Pub. No.: US 2025/0253377 A1
(43) Pub. Date: Aug. 7, 2025

(54) Electrochemical Cell Assembly with Insert

(71) Applicant: Ceres Power Limited, Horsham, West Sussex (GB)

(72) Inventors: Andrew BALLARD, Horsham, West Sussex (GB); Michael TRUEBODY, Horsham, West Sussex (GB); Alastair JAY, Horsham, West Sussex (GB); Nils GIESSELMANN, Waiblingen (DE)

(21) Appl. No.: 18/854,026

(22) PCT Filed: Apr. 4, 2022
(86) PCT No.: PCT/EP2022/058887

§ 371 Date: Oct. 3, 2024

(51) Int. Cl. H01M 8/2485; H01M 8/12; H01M 8/248

(52) U.S. Cl. CPC H01M 8/2485; H01M 8/248; H01M 2008/1293

(57) ABSTRACT

The invention relates to an electrochemical cell assembly including a first end plate assembly, a stack of cell repeat units, and a second end plate assembly. The stack is held in a compressed state between the first end plate assembly and the second end plate assembly. The first end plate assembly and/or the second end plate assembly each include an end plate. The electrochemical cell assembly includes an insulation plate located between the end plate and the stack. At least one through-hole is provided in the insulation plate and a sealing insert is provided in the at least one through-hole of the insulation plate, the sealing insert defining a fluid pathway along the stacking direction. The invention also relates to an end plate assembly and a method of manufacturing an electrochemical cell assembly.

### FIELD OF THE DISCLOSURE

The invention relates to electrochemical cell assemblies and to end plate assemblies for use in an electrochemical cell assembly, as well as to methods of manufacturing an electrochemical cell assembly. More specifically, the invention relates to the field of fuel cells and electrolyser cells and stacks thereof, including metal-supported solid oxide cells and stacks thereof.

### BACKGROUND

Fuel cells and electrolyser cells are examples of electrochemical cells. Fuel cells are energy conversion devices that allow for conversion of electrochemical fuel to electricity. Electrolyser cells are fuels cells running in reverse mode, i.e. using electricity to generate chemicals. Reversible cells are capable of operating in both modes.

Typically, multiple of such cell units are stacked upon one another to form a “stack” of cell repeat units. Said stack may be held in a compressed state between two end plates provided on opposite sides of the stack, thus forming an electrochemical cell assembly. The end plates, in addition to said compression function, typically serve as access points for supplying the cell stack with fuel and/or for electrically contacting the cell stack.

In such electrochemical cell assemblies, an insulation plate may be provided between the end plate and the stack of cell repeat units in order to electrically insulate the end plate from the cell stack. Said insulation plate may comprise through-holes to form fluid pathways for supplying fluid, in particular fuel, to the cell stack. In order to avoid leakage of fuel, said through-holes may be sealed against the stack of cell repeat units by respective gaskets, said gaskets typically being located on the surface of the insulation plate that is facing the stack of cell repeat units.

Mechanical loads applied during compression of the stack of cell repeat units may cause unfavourable mechanical stresses and deformations in the components of the stack of cell repeat units.

It is an object of the present invention to improve sealing and load distribution in an electrochemical cell assembly.

### SUMMARY

According to the invention there is provided an electrochemical cell assembly according to claim 1. The electrochemical cell assembly comprises a first end plate assembly, a stack of cell repeat units, and a second end plate assembly. The stack of cell repeat units comprises a plurality of cell repeat units stacked upon one another along a stacking direction. The stack of cell repeat units is held in a compressed state between said first end plate assembly and said second end plate assembly. For this, the end plate assembly may comprise additional compression means for tensioning said first end plate assembly and said second end plate assembly towards each other along the stacking direction. Such compression means are known in the art, and may e.g. include tension rods, compression springs or bolts, clamps or other means for compression. The first and the second end plate assemblies preferably are provided on opposite sides of the stack of cell repeat units.

The first end plate assembly and/or the second end plate assembly, preferably the first end plate assembly and the second end plate assembly, each comprise an areally extending end plate and an areally extending insulation plate. The insulation plate is located between the end plate and the stack of cell repeat units. Preferably, the end plate and the insulation plate both areally extend in a direction perpendicular to the stacking direction and in parallel to each other. That is to say, the insulation plate may be stacked upon the end plate along the stacking direction. At least one through-hole is provided in said insulation plate. Preferably, the at least one through-hole extends along the stacking direction. According to the invention, a sealing insert is provided and received in said at least one through-hole in the insulation plate. Hence, the first end plate assembly and/or the second end plate assembly each comprise at least one sealing insert received in a corresponding through-hole in the insulation plate. The sealing insert defines a fluid pathway along the stacking direction, preferably for supplying fuel to the stack of cell repeat units.

The proposed configuration allows for improved sealing of the electrochemical cell assembly without causing undue compression on the cell stack that may damage the cell repeat units. More specifically, as the sealing inserts are received in the through-holes of the insulation plate, compression forces introduced into the sealing inserts by the end plates are transferred directly to the stack of cell repeat units, preferably without transferring load to the insulation plate. Thus, a load path via the sealing inserts may be decoupled from a load path via the insulation plate, which allows for applying location-dependent compression forces. This may particularly be advantageous for embodiments of the electrochemical cell assembly where the stack of cell repeat units comprises gaskets (e.g. to seal adjacent cell repeat units) at positions locally corresponding to the sealing inserts (described in detail below). For example, load transferred to said gaskets may be enhanced over load transferred to other regions of the stack, thus ensuring fluid-tight sealing, while avoiding damage to other parts of the cell unit (e.g. to electrochemically active layers of the cell units).

Preferably, both the first and the second end plate assemblies are configured as described above. Preferably, the sealing insert is provided separately from the insulation plate. That is to say, the sealing insert is preferably provided as a separate component and is then inserted into the respective through-hole.

Preferably, the insulation plate comprises two or more through-holes. Thus, the first and/or the second end plate assembly may comprise two or more sealing inserts, each of said sealing inserts being received in a corresponding through-hole in the insulation plate. This, however, does not exclude that the insulation plate may comprise additional through-holes that do not receive a sealing insert (e.g. through-holes for different purpose). In a preferred embodiment, the insulation plate may comprise four through-holes.

The cell repeat units may be fuel cell units, electrolyser cell units or reversible cell units. The cell repeat units may be metal-supported electrochemical cell units. The cell repeat units may be solid oxide fuel cell units or solid oxide electrolyser cell units. The cell units each may comprise multiple layers, including a mechanical support layer, electrochemically active layers, and, optionally, a spacer or interconnector. The electrochemically active layers may comprise a fuel electrode layer, an electrolyte layer and an air or oxidant electrode layer. The electrochemically active layers may be deposited (e.g. as thin coatings or films) on and supported by the mechanical support layer, e.g. by a metal support plate, such as a metal foil.

The cell repeat units may comprise at least one, preferably two or more, through-holes, said through-holes being in fluid communication with the active layers of the cell units allowing for fluid entering and exiting the cell units (e.g. via respective fluid channels). Thus, the through-holes in the cell units may form fluid e.g. fuel ports of the cell units. The stack of cell repeat units may further comprise gaskets, preferably sealing rings, configured to seal said fluid ports of the cell repeat units. In the stack, the column of fluid ports of the stacked cell repeat units and the optional gaskets of the stack of cell repeat units together form a fluid pathway (or chimney) extending along the stacking direction, said fluid pathway serving as an internal manifold for distributing fluid inside the stack of cell repeat units. The stack of cell repeat units, in addition to the cell repeat units, may comprise further components, such as electrical connectors, electrical contact (or current collection) plates (e.g. monopole or endpole plates) or additional sealing gaskets.

In some embodiments, the sealing insert may be configured such that at least in an uncompressed state of the electrochemical cell assembly (that is when the stack of cell repeat units is placed between the first and the second end plate assembly but said first and second end plate assemblies are not tensioned towards each other with the final compression force yet), the sealing insert extends out of the corresponding through-hole in the insulation plate. That is to say, the sealing insert may protrude over the surface of the insulation plate that is facing the stack of cell repeat units. For this, the sealing insert may have a longitudinal extent along the stacking direction exceeding the thickness of the insulation plate. Such a configuration has the advantage that in the uncompressed state, the stack of cell repeat units is supported, preferably only, by the at least one sealing insert. In such a configuration, when compressing the stack of cell repeat units, load is predominantly introduced into the stack of cell repeat units at the positions of the sealing inserts until the stack of cell repeat units bears against the insulation plate. This may particularly be advantageous for embodiments, where the stack of cell repeat units comprises fluid ports and gaskets as described above at positions locally corresponding to the through-holes in the insulation plate. In this case, the gaskets of the stack of cell repeat units may be compressed to ensure fluid-tight sealing.

The sealing insert may be configured such that in the assembled (compressed) state of the electrochemical cell assembly (that is when the stack of cell repeat units is held in a compressed state between the first and the second end plate assemblies), the sealing insert still extends out of the through-hole.

Alternatively, the sealing insert may be designed such that in the assembled (compressed) state of the electrochemical cell assembly an upper surface of the sealing insert, said upper surface facing the stack of cell repeat units, is positioned flush with a surface of the insulation plate, said surface of the insulation plate facing the stack of cell repeat units. That is to say, the insulation plate and the sealing insert may be configured such that in the assembled state of the electrochemical cell assembly there is provided a levelled support for the stack of cell repeat units. This reduces mechanical stresses that may lead to bending or deformation of the stack of cell repeat units (e.g. a deformation of a current collection plate located adjacent to the insulation plate). Preferably, the stack of cell repeat units is held in a compressed state between said first and second end plate assemblies such that the stack of cell repeat units bears against the surface of the insulation plate (e.g. with a current collection plate located adjacent to the insulation plate), which may support compression of the active areas of the cell units.

In some embodiments, the sealing insert may comprise at least one sleeve received in the corresponding through-hole in the insulation plate, said at least one sleeve defining a fluid channel along the stacking direction. For this, the sleeve may define an inner cavity extending along the stacking direction. The at least one sleeve may be a hollow cylinder, the hollow space of said hollow cylinder forming the fluid channel. The sealing insert may comprise only one sleeve. Alternatively, the sealing insert may comprise multiple sleeves stacked along the stacking direction.

In some embodiments, in addition to the at least one sleeve, the sealing insert may comprise at least one gasket configured to seal the fluid channel against the stack of cell repeat units. The at least one gasket may be a sealing ring or a sealing sheet. The at least one gasket may be positioned around the fluid channel, preferably coaxially to the fluid channel. Optionally, the sealing insert may further comprise at least one gasket configured to seal the fluid channel against the end plate.

In some embodiments, the sealing insert may comprise a single sleeve, wherein a first gasket is provided on a first face of said single sleeve, said first face of the single sleeve facing the stack of cell repeat units. Optionally, a second gasket may be provided on a second face of the single sleeve, said second face of said single sleeve facing the end plate. In such a configuration, the sleeve supports the gasket or gaskets, thus leading to reliable force introduction into the gaskets.

Preferably, the sleeve and, optionally, the at least one gasket, are formed from a mechanically compressible material. In the context of this application, a component “formed from” a specific material may mean that said component is mainly composed (for the most part consists of said material) of said specific material or consists of said specific material. The component may be produced with said specific material being the main source material for constructing it.

Preferably, the sleeve and, optionally, the at least one gasket, is compressible such that in the assembled state of the electrochemical cell assembly, an upper surface of the first gasket (provided on the first face of the sleeve), said upper surface facing the stack of cell repeat units, is positioned flush with the surface of the insulation plate facing the stack of cell repeat units. Hence, in the assembled state of the electrochemical cell assembly, there is provided levelled support for the stack of cell repeat units and the insulation plate may support the stack. Optionally, in embodiments comprising a second gasket (provided on the second face of the single sleeve), a surface of said second gasket, said surface facing the end plate, is positioned flush with a surface of the insulation plate, said surface of the insulation plate facing the end plate.

In some embodiments, the sealing insert may consist of a single sleeve. The single sleeve may be formed from a mechanically compressible material. Preferably, the single sleeve is compressible such that in the assembled state of the electrochemical cell assembly, a first face of the single sleeve, said first face facing the stack of cell repeat units, is positioned flush with the surface of the insulation plate facing the stack of cell repeat units. The single sleeve may be formed from a ceramic material. Alternatively, the single sleeve may be formed from mica.

In some embodiments, the sealing insert may comprise a plurality of sleeves and gaskets, said plurality of sleeves and gaskets preferably being stacked along the stacking direction in an alternating fashion. Thus, the sealing insert may comprise a multilayer of sleeves and gaskets stacked upon each other in an alternating fashion. Such a multilayer design allows for better load distribution and, thus, reduces a risk of deformation of the stack of cell repeat units in the compressed state. Depending on the thickness of the insulation plate, the number of sleeve-gasket-pairs may be adjusted. Preferably, the number of sleeve-gasket-pairs is chosen such that in the assembled state of the electrochemical cell assembly, an upper surface of the (multilayer) sealing insert, said upper surface facing the stack of cell repeat units, is positioned flush with the surface of the insulation plate facing the stack of cell repeat units and, optionally, a lower surface of the (multilayer) sealing insert is positioned flush with a surface of the insulation plate facing the end plate. Advantageously, the sealing insert may be designed such that a gasket forms the top layer of the multilayer, said top layer facing the stack of cell repeat units. Alternatively or in addition, the sealing insert may be designed such that a gasket forms the bottom layer of the multilayer, said bottom layer facing the end plate.

According to a general aspect, the sealing insert may extend through the through-hole along its entire length. Preferably, the sealing insert abuts the end plate in the assembled state of the electrochemical cell assembly. Preferably, the sealing insert abuts the end plate with a gasket. That is to say, the lower most layer of the sealing insert, said lower most layer facing the end plate, preferably is a gasket. This allows for improved sealing of the fuel pathway against the end plate.

According to a further general aspect, the at least one through-hole and the corresponding sealing insert may be designed such that in the assembled state of the electrochemical cell assembly (that is when the sealing insert is received in the through-hole and the stack of cell repeat units is held in a compressed state between the first end plate assembly and the second end plate assembly), the sealing insert, in particular the at least one sleeve, is force-fittingly held in the through-hole, e.g. due to transverse strain due to the compression. This further improves sealing and electrical insulation of the fluid pathway.

Alternatively, through-hole and corresponding sealing insert may be designed such that in the assembled state of the chemical cell assembly an annular gap is present between the insulation plate and the sealing insert (more specifically, between the walls defining the through-hole and the sealing insert). This further improves load decoupling between the sealing insert and the insulation plate.

In such embodiment, but also in general, it may be advantageous if a secondary insulation plate is located between the (primary) insulation plate discussed above and the end plate. The secondary insulation plate may help to mitigate against electrical insulation risk in the annular gap as it removes direct line of sight between the stack of cell repeat units (in particular the current collection) and the end plate. Preferably, the secondary insulation plate has a thickness along the stacking direction that is smaller than the thickness of the (primary) insulation plate along the stacking direction. Preferably, a ratio between the thickness of the secondary insulation plate and the thickness of the insulation plate is less than 0.5, more preferably less than 0.4, still more preferably less than 0.3, still more preferably less than 0.2, still more preferably less than 0.1.

The secondary insulation plate may comprise at least one through-hole. Preferably, each through-hole in the insulation plate is assigned a corresponding through-hole in the secondary insulation plate. Preferably, said through-hole or through-holes in the secondary insulation plate are located at positions locally corresponding to the corresponding through-hole or through-holes in the insulation plate. The diameter of the at least one through-hole of the secondary insulation plate may be smaller than the diameter of the at least one through-hole in the insulation plate. Preferably, the diameter of the at least one through-hole of the secondary insulation plate is equal or larger than the diameter of the fluid channel defined by the sealing insert.

According to a general aspect, the insulation plate and/or the secondary insulation plate may be formed from of an electrically insulating material. Preferably, the insulation plate and/or the secondary insulation plate are formed from mica.

According to a further general aspect, the at least one sleeve and/or the at least one gasket may be formed from an electrically insulating material. The at least one sleeve and/or the at least one gasket may be formed from mica. Alternatively, the at least one sleeve and/or the at least one gasket may be formed from a ceramic material. Ceramic materials have the advantage of high mechanical stiffness and superior creep stability, thus improving long-time sealing function. Preferably, the at least one gasket is formed from Thermiculite (registered trademark of the Flexitalic group). In a preferred embodiment, the at least one sleeve is formed from a ceramic material and the at least one gasket is formed from Thermiculite. In an alternative preferred embodiment, the at least one sleeve is formed from mica and the at least one gasket is formed from Thermiculite.

According to a further general aspect, at least one through-hole may be provided in the end plate to form a fluid connection for the electrochemical cell assembly. Preferably, the at least one through-hole in the end plate is arranged in fluid communication with, more preferably coaxially to, the at least one through-hole in the insulation. Preferably, the end plate and the insulation plate each comprise a plurality of through-holes, wherein each through-hole in the insulation plate is assigned a corresponding through-hole in the end plate, said through-hole in the end plate and said corresponding through-hole in the insulation plate being arranged in fluid communication with, more preferably coaxially to, each other.

Additionally, the end plate may be provided with at least one additional through-hole forming an air or oxidant port. The insulation plate may be designed and arranged such that the insulation plate at least partially surrounds the at least one additional through-hole, allowing for improved sealing of the at least one additional through-hole.

The invention also relates to an end plate assembly, preferably for use in an electrochemical cell assembly as discussed above. The features and advantages explained above in connection with the first and second end plate assembly of the electrochemical cell assembly are also applicable to the end plate assembly according to claim 25. The end plate assembly comprises an end plate and an insulation plate, said insulation plate and said end plate being stacked upon another along a stacking direction, said stacking direction preferably equating the intended stacking direction of the cell repeat units in the electrochemical cell assembly. At least one through-hole is provided in said insulation plate. Preferably, the at least one through-hole extends along the stacking direction. Furthermore, a sealing insert is provided in said at least one through-hole of the insulation plate, said sealing insert defining a fluid pathway along the stacking direction.

Preferably, the sealing insert, at least in a state in which the end plate assembly is not incorporated in the electrochemical cell assembly yet, has a longitudinal extent in direction of the through-hole, preferably along the stacking direction, exceeding the thickness of the insulation plate. That is to say, the sealing insert preferably extends out of the through-hole in an uncompressed state of the end plate assembly.

The invention also relates to a method of manufacturing an electrochemical cell assembly. The method comprises a step of providing a first end plate assembly, a plurality of cell repeat units, and a second end plate assembly, at least one of said first and second end plate assemblies, more preferably both end plate assemblies, being constituted as described above. That is to say, the first and/or the second end plate assemblies each comprise an end plate, an insulation plate, and at least one sealing insert as described above. The method further comprises a step of positioning the cell repeat units in a stacked order along a stacking direction between the first end plate assembly and the second end plate assembly to form a stack of cell repeat units. The method further comprises a step of compressing said cell repeat units along the stacking direction by tensioning said first end plate assembly and said second end plate assembly towards each other along the stacking direction.

Preferably, the cell repeat units are compressed along the stacking direction by tensioning said first end plate assembly and said second end plate assembly towards each other until, in the at least one end plate assembly that is constituted as described above, an upper surface of the sealing insert, said upper surface facing the stack of cell repeat units, is positioned flush with a surface of the insulation plate, said surface facing the stack of cell repeat units. Preferably, the cell repeat units are compressed along the stacking direction by tensioning said first end plate assembly and said second end plate assembly towards each other until the stack of cell repeat units bears against the surface of the insulation plate.

### BRIEF DESCRIPTION OF THE FIGURES

Further embodiments are derivable from the following description and the drawings.

In the drawings:

FIG. 1 shows a perspective view of an embodiment of an electrochemical cell assembly;

FIG. 2a shows a cross-sectional view of the electrochemical cell assembly according to FIG. 1;

FIG. 2b shows a detail of FIG. 2a;

FIG. 3a shows a perspective section of the electrochemical cell assembly according to FIG. 1;

FIG. 3b shows a detail of FIG. 3a;

FIG. 4 shows a perspective view of an end plate assembly of the electrochemical cell assembly according to FIG. 1;

FIG. 5 shows an exploded perspective view of the end plate assembly according to FIG. 4;

FIG. 6a shows a top view of the end plate assembly according to FIG. 4

FIG. 6b shows a section through the end plate assembly according to FIG. 6a along the section line VIb-VIb drawn in FIG. 6a;

FIG. 6c shows a detail of FIG. 6b;

FIG. 7 shows a detail of a further embodiment of the electrochemical cell assembly;

FIG. 8 shows a detail of a further embodiment of the electrochemical cell assembly;

FIG. 9 shows a detail of a further embodiment of the electrochemical cell assembly.

Repeat use of reference symbols in the present specification and drawings is intended to represent the same or analogous features or elements.

### DETAILED DESCRIPTION

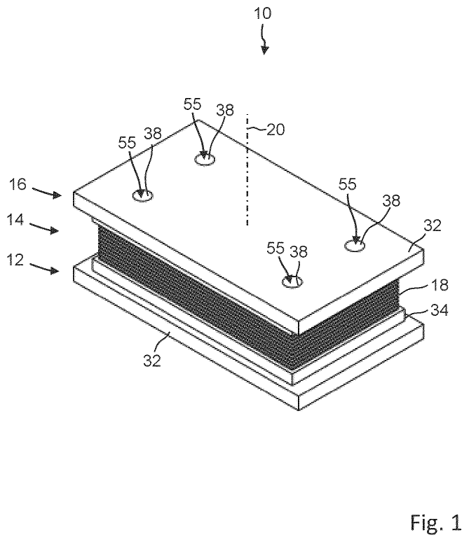

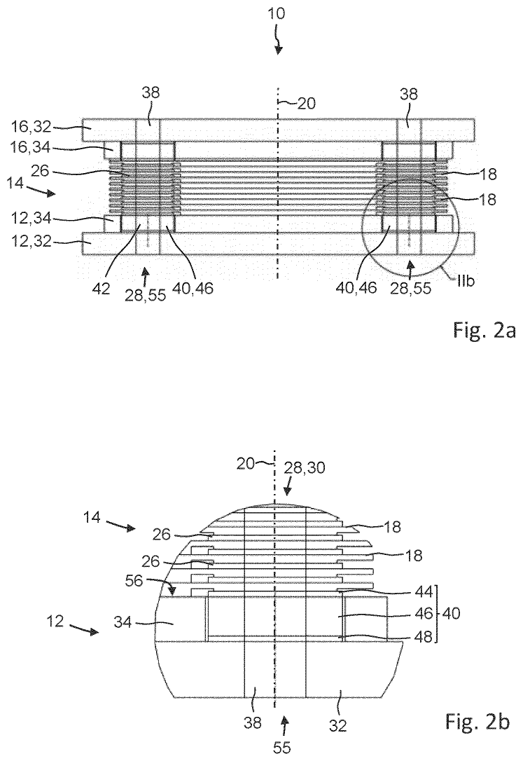

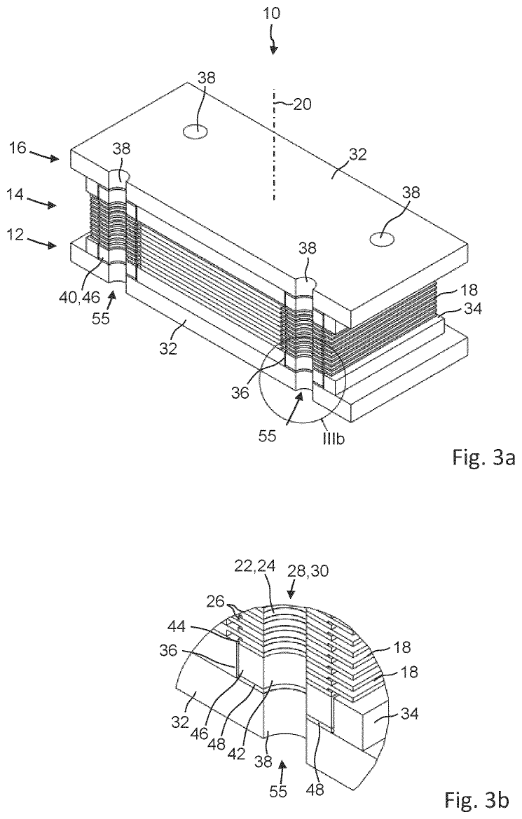

FIG. 1 schematically shows an outline of an exemplary embodiment of an electrochemical cell assembly 10. The electrochemical cell assembly 10 comprises a first end plate assembly 12, a stack 14 of cell repeat units 18 and a second end plate assembly 16 (see also FIG. 2 and FIG. 3). In the assembled state, the stack 14 of cell repeat units is held in a compressed state between the first end plate assembly 12 and the second end plate assembly 16. For this, the electrochemical cell assembly 10 may comprise additional compression means known in the art (not shown), such as tension rods, compression springs or bolts.

The stack 14 of cell repeat units comprises a plurality of cell repeat units 18, said cell repeat units 18 being stacked upon each other along a stacking direction 20 (see FIGS. 2a and 3b). As set out above, the cell repeat units 18 may be fuel cell units, electrolyser cell units or reversible cell units comprising electrochemically active layers (not shown).

Referring to FIGS. 3a and 3b, it can be seen that each cell repeat unit 18 preferably comprises two or more, in the example four, through-holes 22, said through-holes 22 being in fluid communication with the active layers of the cell unit 18, e.g. via respective fluid channels (not shown). Thus, the through-holes 22 form fluid ports 24 of the respective cell repeat units 18. In the embodiment shown, the stack 14 of cell repeat units 18 further comprises optional sealing gaskets 26 located between the individual cell repeat units 18 and configured to seal the fluid ports 24 against adjacent cell repeat units 18 (see FIGS. 2b and 3b).

As shown in FIGS. 3a and 3b, the column of fluid ports 24 and gaskets 26 together form a fluid pathway 28 extending throughout the stack 14 of sealing repeat units 18 along the stacking direction 20. Said fluid pathway 28 serves as an internal manifold 30 for distributing fuel to the individual cell repeat units 18. In the embodiment shown, the electrochemical cell assembly comprises four of such manifolds 30.

In the embodiment shown, exemplarily, the first end plate assembly 12 and the second end plate assembly 16 are configured identically. In the following, the structure of the end plate assemblies 12, 16 is described by way of example using the first end plate assembly 12.

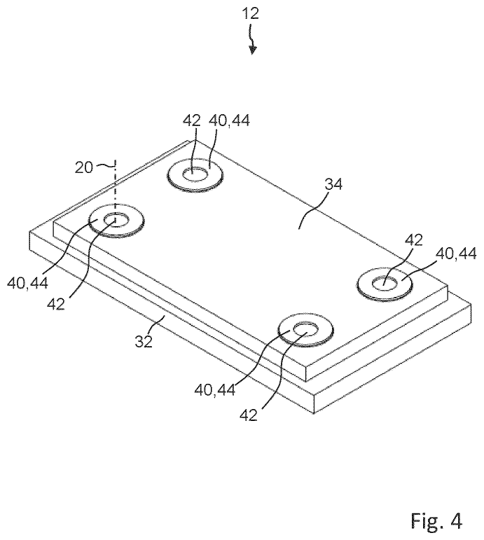

FIG. 4 shows a perspective view of the first end plate assembly 12. The end plate assembly 12 comprises an end plate 32 and an insulation plate 34. The end plate 32 and the insulation plate 34 are stacked upon each other along the stacking direction 20. In the electrochemical cell assembly 10, the insulation plate 34 is located between the end plate 32 and the stack 14 of cell repeat units 18 (see e.g. FIG. 3a).

Preferably, the insulation plate 34 is formed from an electrically insulating material, more preferably from mica.

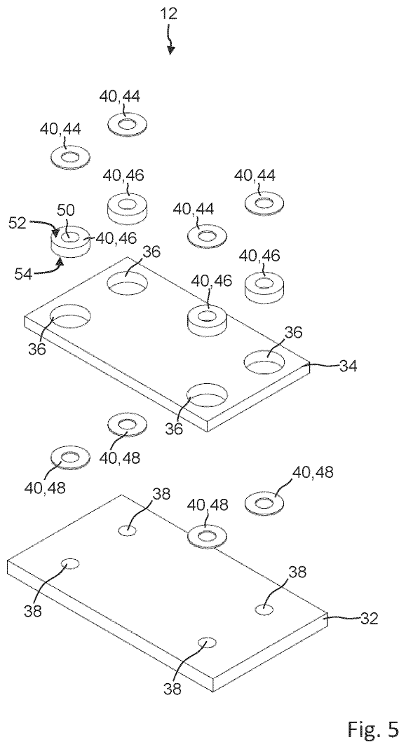

The insulation plate 34 comprises a plurality of through-holes 36 extending along the stacking direction 20 (see FIG. 5). In the example shown, the insulation plate 34 comprises four through-holes 36, said through-holes 36, in the assembled cell assembly 10, being arranged coaxially to the fluid ports 24 of the cell repeat units 18 in the electrochemical cell assembly 10 (see e.g. FIG. 3b).

In this embodiment, the end plate 32 also comprises a plurality of, in the example four, through-holes 38 extending along the stacking direction 20 and arranged at positions locally corresponding to the positions of the through-holes 36 in the insulation plate 34 (see FIG. 5). Preferably, the through-holes 38 in the end plate 32 are arranged coaxially to the through-holes 36 in the insulation plate 34 and to the through-holes 22 in the cell repeat units 18. Preferably, the diameter of the through-holes 38 in the end plate 32 is smaller than the diameter of the through-holes 36 in the insulation plate 24.

Referring to FIG. 4, it can be seen that a sealing insert 40 is received in each of the through-holes 36 in the insulation plate 34. That is, the end plate assembly 12, 16 further comprises a plurality of sealing inserts 40 provided in the through-holes 36 of the insulation plate 34. Each sealing insert 40 defines a central fluid pathway 42 along the stacking direction for supplying fluid to the stack 14 of cell repeat units 18.

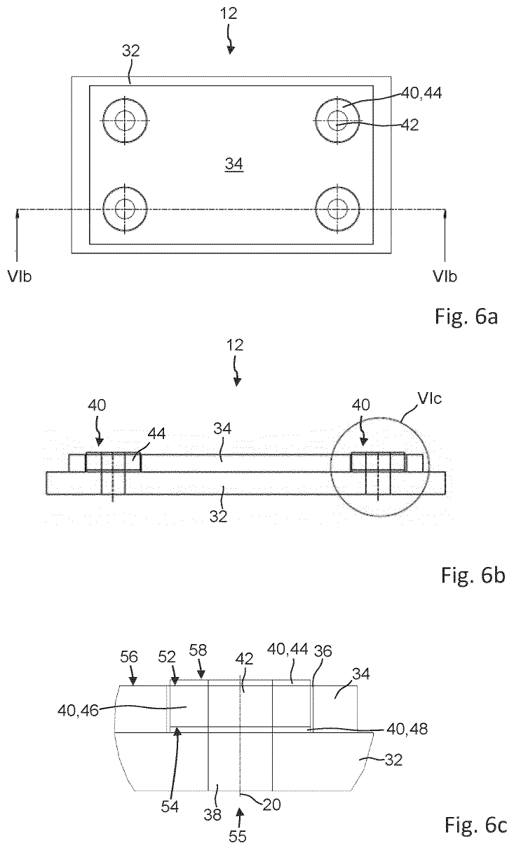

In the embodiment of FIGS. 1 to 6, each sealing insert 40 comprises a first gasket 44, a sleeve 46, and a second gasket 48, stacked upon one another along the stacking direction 20 (see FIG. 6c). The gaskets 44, 48 preferably are sealing rings. As can be seen from FIG. 5, the sleeve 46 has the shape of a hollow cylinder defining a central fluid channel 50 along the stacking direction 20. The gaskets 44, 48 are configured to seal said fluid channel 50 against the stack 14 of cell repeat units 18 (first gasket 44) and against the end plate 32 (second gasket 48). More specifically, the first gasket 44 is provided on a first face 52 of the sleeve 46, said first face 52 facing the stack 14 of cell repeat units 18 (see FIG. 6c). Thus, in the assembled state of the electrochemical cell assembly 10, the first gasket 44 bears against the stack 14 of cell repeat units 18 (see e.g. FIG. 2b). The second gasket 48 is provided on an opposite second face 54 of the sleeve 46, said second face 54 facing the end plate 32 (see FIG. 6c). Thus, in the assembled state of the electrochemical cell assembly 10, the second gasket 48 bears against the end plate 32.

Referring to FIGS. 2b and 3b, it can be seen that in the assembled state the through-holes 38 in the end plates 32, the second gaskets 48, the sleeves 46 (fluid channels 50), the first gaskets 44, the fluid ports 24, and the gaskets 26 of the stack 14 of cell repeat units 18 are arranged coaxially to each other, thus together forming a chimney 55 extending along the stacking direction 20 and, preferably, throughout the entire thickness of the electrochemical cell assembly 10. In the embodiment shown, the electrochemical cell assembly comprises four of such chimneys 55 (see FIG. 1).

As shown in FIGS. 6b and 6c the sealing insert 40 preferably is designed such that at least in the uncompressed state (that is before the first end plate assembly 12 and the second end plate assembly 16 are tensioned towards each other to compress the stack 14 of cell repeat units 18), the sealing insert 40 protrudes from a top surface 56 of the insulation plate 34, said top surface 56 facing the stack 14 of cell repeat units 18. That is to say, the sealing insert 40 preferably has a longitudinal extent along the stacking direction 20 exceeding the thickness of the insulation plate 34.

The sealing insert 40 is designed such that in the compressed state of the electrochemical cell assembly 10, an upper surface 58 of said sealing insert 40 (in the embodiment shown, the upper surface 58 of the first gasket 44), said upper surface 58 facing the stack 14 of cell repeat units 18, is positioned flush with surface 56 of the insulation plate 34 that is facing the stack 14 of cell repeat units 18. In this way, there is provided a levelled support for the stack 14 of cell repeat units 18, when the stack 14 of cell repeat units is held in a compressed state between the first end plate assembly 12 and the second end plate assembly 16.

For this, the sleeve 46 and/or the gaskets 44, 48 are preferably formed from a mechanically compressible material. For example, the sleeve 46 may be formed from mica. Alternatively, the sleeve 46 may be formed from a ceramic material. The first and second gaskets 44, 48 preferably are formed from an electrically insulating material. For example, the first and second gaskets 44, 48 may be formed from Thermiculite material.

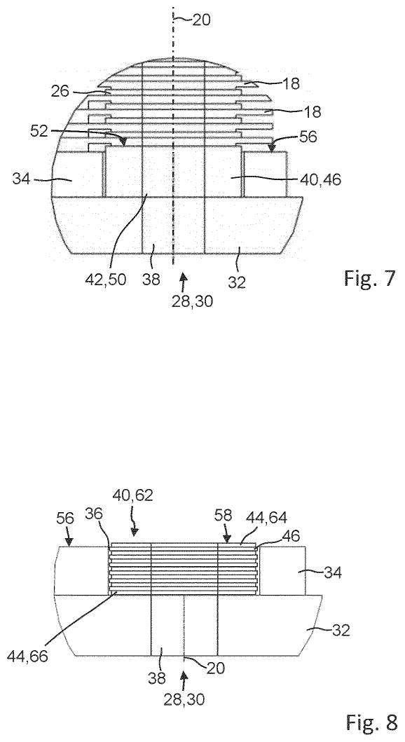

Referring to FIG. 7, there is shown a further embodiment of the sealing insert 40, wherein the sealing insert 40 consists of a single sleeve 46. The single sleeve 46 may have a longitudinal extent along the stacking direction 20 exceeding the thickness of the insulation plate 34. That is, the single sleeve 46 may extend out of the respective through-hole 36 in the insulation plate 34 in an uncompressed state of the end plate assembly 12. Preferably, the single sleeve is compressible such that in the assembled state of the electrochemical cell assembly 10, a first face 52 of the single sleeve 46, said first face 52 facing the stack 14 of cell repeat units 18, is positioned flush with the surface 56 of the insulation plate 34 that is facing the stack 14 of cell repeat units 18.

Referring to FIG. 8, there is shown a further embodiment of the sealing insert 40, wherein the sealing insert 40 comprises a multilayer 62 of sleeves 46 and gaskets 44 stacked upon one another along the stacking direction 20 in an alternating fashion. The number of sleeve-gasket-pairs may be chosen such that, in the compressed state of the electrochemical cell assembly 10, the top surface 58 of the (multilayer) sealing insert, said top surface 58 facing the stack 14 of cell repeat units 18 is positioned flush with the surface 56 of the insulation plate 34 that is facing the stack 14 of cell repeat units 18. As shown in FIG. 8, preferably both the top layer 64 and the bottom layer 66 of the multilayer 62 are provided by a gasket 44.

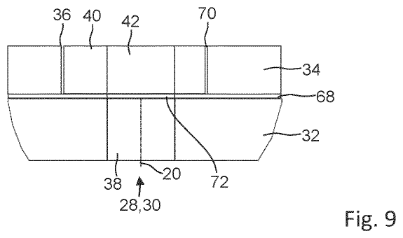

Referring to FIG. 9, there is shown a detail of a further embodiment of the end plate assembly 12, wherein a secondary insulation plate 68 is provided between the end plate 32 and the (primary) insulation plate 34. The sealing insert 40 (in FIG. 9 only schematically shown) may be designed according to any one of the exemplary embodiments described before (e.g. single sleeve, single sleeves with gaskets, multilayer, . . . ). The sealing insert 40 is supported by the secondary insulation plate 68. In this embodiment, the sealing insert 40 may be designed such that in an compressed state of the electrochemical cell assembly 10 an annular gap 70 is present between the sealing insert 40 and the insulation plate 34. This further helps to decouple the load path between the gasket chimney 28 (manifold 30) and the active areas of the cell repeat units 18.

As exemplarily shown in FIG. 9, the secondary insulation plate 68 comprises through-holes 72 at positions locally corresponding to the through-holes 36 in the insulation plate 34 and the through-holes 38 in the end plate 34. Preferably, the through-holes 36, 38, 72 are arranged coaxially to each other. Preferably, the diameter of the through-holes 72 in the secondary insulation plate 68 is smaller than the diameter of the through-holes 36 in the insulation plate 34. The secondary insulation plate 68 may be formed from the same material as the (primary) insulation plate 34, e.g. from mica. Preferably, the thickness of the secondary insulation plate 68 along the stacking direction 20 is smaller than the thickness of the (primary) insulation plate 34 along the stacking direction.

1. An electrochemical cell assembly comprising
a first end plate assembly,
a stack of cell repeat units, comprising a plurality of cell repeat units stacked upon one another along a stacking direction, and
a second end plate assembly said stack of cell repeat units being held in a compressed state between said first end plate assembly and said second end plate assembly, said first end plate assembly and/or said second end plate assembly each comprising:
an end plate and
an insulation plate located between said end plate and said stack of cell repeat units,
wherein at least one through-hole is provided in the insulation plate, and wherein a sealing insert is received in the at least one through-hole of the insulation plate, said sealing insert defining a fluid pathway along the stacking direction.

2. The electrochemical cell assembly according to claim 1, wherein the sealing insert is designed such that in the assembled state of the electrochemical cell assembly, an upper surface of said sealing insert, said upper surface facing the stack of cell repeat units, is positioned flush with a surface of the insulation plate, said surface of the insulation plate facing the stack of cell repeat units.

3. The electrochemical cell assembly according to claim 1, wherein the sealing insert comprises at least one sleeve, the at least one sleeve defining a fluid channel along the stacking direction.

4. The electrochemical cell assembly according to claim 3, wherein the sealing insert comprises at least one gasket configured to seal the fluid channel against the stack of cell repeat units and, optionally, at least one gasket configured to seal the fluid channel against the end plate.

5. The electrochemical cell assembly according to claim 1, wherein the sealing insert comprises a single sleeve, wherein a first gasket is provided on a first face of the single sleeve facing the stack of cell repeat units and, optionally, a second gasket is provided on a second face of the single sleeve facing the end plate.

6. The electrochemical cell assembly according to claim 5, wherein the single sleeve and, optionally, the at least one gasket, is compressible such that in the assembled state of the electrochemical cell assembly, an upper surface of the first gasket, said upper surface facing the stack of cell repeat units, is positioned flush with a surface of the insulation plate, said surface facing the stack of cell repeat units.

7. The electrochemical cell assembly according to claim 1, wherein the sealing insert consists of a single sleeve, the single sleeve being compressible such that in the assembled state of the electrochemical cell assembly, a first face of the single sleeve, said first face facing the stack of cell repeat units, is positioned flush with a surface of the insulation plate, said surface of the insulation plate facing the stack of cell repeat units.

8. The electrochemical cell assembly according to claim 1, wherein the sealing insert comprises a plurality of sleeves and gaskets, said sleeves and gaskets being stacked alternately along the stacking direction to form a multilayer.

9. (canceled)

10. The electrochemical cell assembly according to claim 1, wherein the sealing insert extends through the through-hole in the insulation plate and, optionally, abuts the end plate.

11. The electrochemical cell assembly according to claim 1, wherein the sealing insert abuts the end plate with a gasket.

12. The electrochemical cell assembly according to claim 1, wherein through-hole and corresponding sealing insert are designed such that in the assembled state of the electrochemical cell assembly the sealing insert is force-fittingly held in the through-hole.

13. The electrochemical cell assembly according to claim 1, wherein through-hole and corresponding sealing insert are designed such that in the assembled state of the electrochemical cell assembly an annular gap is present between the insulation plate and the sealing insert.

14. The electrochemical cell assembly according to claim 1, wherein a secondary insulation plate is located between the insulation plate and the end plate.

15. The electrochemical cell assembly according to claim 13, wherein the secondary insulation plate has a thickness along the stacking direction that is smaller than the thickness of the insulation plate along the stacking direction.

16. (canceled)

17. The electrochemical cell assembly according to claim 13, wherein the secondary insulation plate comprises at least one through-hole at a position locally corresponding to the position of the at least one through-hole of the insulation plate, the diameter of the at least one through-hole of the secondary insulation plate preferably being smaller than the diameter of the at least one through-hole of the insulation plate.

18. (canceled)

19. The electrochemical cell assembly according to claim 1, wherein the at least one sleeve and/or the at least one gasket are formed from an electrically insulating material.

20. The electrochemical cell assembly according to claim 1, wherein the at least one sleeve is formed from a ceramic material.

21-24. (canceled)

25. An end plate assembly for use in an electrochemical cell assembly, said end plate assembly comprising:
an end plate, and
an insulation plate,
said insulation plate and said end plate being stacked upon one another along a stacking direction,
wherein at least one through-hole is provided in said insulation plate, and wherein a sealing insert is received in said at least one through-hole of the insulation plate, said sealing insert defining a fluid pathway along the stacking direction.

26. The end plate assembly according to claim 25, wherein the sealing insert has a longitudinal extent in the direction of the through-hole exceeding the thickness of the insulation plate, in a state in which the end plate assembly is not incorporated in the electrochemical cell assembly yet.

27. A method of manufacturing an electrochemical cell assembly, the method comprising:
providing a first end plate assembly, a plurality of cell repeat units, and a second end plate assembly, wherein at least one of said first and second end plate assemblies is constituted according to claim 25,
positioning said cell repeat units in a stacked order along a stacking direction between said first end plate assembly and said second end plate assembly;
compressing said cell repeat units along the stacking direction by tensioning said first end plate assembly and said second end plate assembly towards each other along the stacking direction.
